(19) United States
(12) Patent Application Publication
(10) Pub. No.: US 2024/0418547 A1
(43) Pub. Date: Dec. 19, 2024

(54) Method for Correcting an Age-Related Deviation of a Sensor Value of a Sensor System

(71) Applicant: Robert Bosch GmbH, Stuttgart (DE)

(72) Inventors: Patrick Tritschler, Engen (DE); Tobias Hiller, Reutlingen (DE)

(21) Appl. No.: 18/742,657

(22) Filed: Jun. 13, 2024

(30) Foreign Application Priority Data
Jun. 16, 2023 (DE) 10 2023 205 657.7

(51) Int. Cl. G01D 18/00; G01D 3/032; G06N 3/08

(52) U.S. Cl. CPC G01D 18/008; G01D 3/032; G06N 3/08

(57) ABSTRACT

A computer-implemented method for recalibrating a trained data-based calibration model for use in a sensor system for measuring one or more physical variables is disclosed. The data-based calibration model is formed as a neural graph network which is trained to output an output vector comprising one or more output variables and a plurality of auxiliary variables, depending on a sensor state graph representing a sensor state. The method includes (i) detecting one or more detection variables relating to the one or more physical variables and one or more state variables indicating one or more environmental influences on the sensor system, (ii) ascertaining a sensor state graph depending on the one or more detection variables and the one or more state variables at a time of detection, (iii) augmenting the sensor state graph, (iv) evaluating the augmented sensor state graph with the data-based calibration model to obtain the output vector, (v) determining a loss depending on the output vector, and (vi) unsupervised training of the calibration model depending on the determined loss.

This application claims priority under 35 U.S.C. § 119 to patent application no. DE 10 2023 205 657.7, filed on Jun. 16, 2023 in Germany, the disclosure of which is incorporated herein by reference in its entirety.

The disclosure relates to sensor systems for detecting at least one sensor variable. The disclosure also relates to measures for correcting ageing effects using a data-based correction model that is adapted or trained in an unsupervised manner during operation of the sensor system.

### BACKGROUND

Sensor systems are usually calibrated after manufacture, as the components used have deviations within a permissible tolerance. Calibration can be carried out on the basis of a mathematical calibration model, wherein the model parameters of the model are adapted to the individual sensor system during the calibration process. For example, measured values for reference states are recorded during the calibration process with the sensor system and the model parameters are adjusted using adjustment algorithms depending on the measured values. The calibration model is integrated into the sensor system so that a detection variable corresponding to the raw sensor data is processed using the calibration model to provide a measured variable.

Depending on where the sensor system is used, the original calibration may no longer be optimally adapted to the sensor system after some operating time and/or due to accumulation effects caused by changing ambient conditions. Although this deviation can be compensated for by recalibration, this is often inadequate due to a lack of knowledge about the exact functioning of the sensor system and its calibration. In addition, the behavior of the sensor system changes over its service life due to ageing effects, so that the calibration model cannot provide a sufficiently good correction of the sensor value in the long term.

Adaptive methods are already known for calibration models in order to adapt them to new conditions after the actual initial calibration process. These are so-called test-time training algorithms, as they are known, for example, from the publications Liu, Yuejiang et al, “TTT++: When Does Self-Supervised Test-Time Training Fail or Thrive?”, 2021 and Sun, Yu et al, ‘Test-Time Training for Out-of-Distribution Generalization’, 2019. The training task here is, for example, image classification using a neural network, wherein unsupervised retraining without a label is described.

### SUMMARY

According to the disclosure, a method for adapting a data-based calibration model for a sensor system and a sensor system are provided.

Further embodiments are also discussed below.

According to a first aspect, a method is provided, in particular a computer-implemented method, for recalibrating a data-based calibration model for use in a sensor system for measuring one or more physical variables, wherein the data-based calibration model is formed as a neural graph network which is trained to output an output vector comprising one or more output variables and a plurality of auxiliary variables depending on a sensor state graph representing a sensor state, comprising the following steps:
detecting one or more detection variables relating to the one or more physical variables (or representing the one or more physical variables) and one or more state variables indicating one or more sensor-internal variables and/or one or more environmental influences on the sensor system;
ascertaining a sensor state graph depending on the one or more detection variables and the one or more state variables at a time of detection;
augmenting the sensor state graph;
evaluating the augmented sensor state graph with the data-based calibration model to obtain the output vector;
determining a loss depending on the output vector;
unsupervised training of the calibration model depending on the determined loss.

In sensor systems, e.g. in integrated sensor systems such as acceleration sensors, gyroscopes, vibration sensors, radiation sensors, capacitive and piezoelectric sensors and the like, calibration is required to compensate for component-specific deviations from a standard behavior. For this purpose, calibration models can be implemented in sensor systems that output an output variable as a correction variable for applying to a detection variable (detected raw sensor data) (to ascertain the sensor output variable) or output a corrected sensor output variable depending on the detection variable.

In this context, a model is generally understood to be a data-based calculation model that can be trained to represent a desired functional relationship.

Due to the diverse influences of ambient factors and the like on the detection variable, the sensor output variable results from a combination of the detection variable with one or more state variables, which can be detected via other sensor elements, using the calibration model. These state variables can, for example, indicate one or more environmental influences on the sensor system, such as a temperature, a humidity, an air pressure, a pollution level, an effect of electromagnetic radiation, an effect of mechanical stress, vibrations and the like. Alternatively or additionally, these state variables may, for example, indicate one or more sensor-internal variables, such as sensor-detected offsets or sensitivities of the sensors for the one or more detection variables, signals from dedicated stress sensors, signals from BITEs (built-in test equipment), signals from the amplitude control or phase control of an actuator in the sensor system, a quality and/or a frequency of detection modes of a sensor or characteristics derived therefrom.

For inertial sensors, these state variables may include one or more of the following: Offsets or sensitivities of the acceleration sensors or angular rate sensors, signals from dedicated stress sensors, detected (detection mode) phase values, signals from BITEs (built-in test equipment), signals from the amplitude or phase control of the drive of an angular rate sensor, qualities and frequencies of the drive or detection modes of an angular rate sensor, qualities and frequencies of the modes of an acceleration sensor, difference of the drive and detection mode frequency of an angular rate sensor, cross-axis sensitivities of the acceleration or angular rate sensor, and differential values or a dynamic response of the quadrature or angular rate when a given quadrature or angular rate stimulus is applied.

Depending on the one or more state variables, a correction can be made to the detection variable for calibration.

The data-based calibration model is adapted or trained once after the sensor system has been manufactured and can be retrained or fine-tuned once again directly after installation in the end application. If the sensor system is now used in an end application, it must be ensured during its service life that the sensor output variable provided can be provided reliably and accurately regardless of ageing and ambient influences. Regular recalibration is therefore generally necessary.

However, no test bench data/training data is usually available for these recalibrations, as the sensor system is installed in an end application and test bench measurement is not possible. Therefore, the recalibration process can only be carried out without labeled data. According to the above method, this is done for a data-based calibration model using an unsupervised training method.

For this purpose, the method provides for the creation of a mathematical graph with nodes and edges based on one or more detection variables and one or more state variables that are detected at a time step or time of detection.

It may be provided that the sensor state graph is ascertained by assigning node variables to nodes of the sensor state graph which correspond to the one or more detection variables and the one or more state variables at the time of detection, and assigning an edge variable to edges of the sensor state graph which connect two nodes of the sensor state graph to each other, which edge variable indicates a correlation between the detection variables or state variables representing the nodes, wherein the correlation is determined in particular, by evaluating the temporal progression of the detection variables or state variables within a predefined time window.

The one or more detection variables and the one or more state variables are therefore referred to as node variables. The graph can have nodes that are each assigned to one of the node sizes. The node values are assumed to be the respective value of the node size at the time of detection. An edge connects two nodes and specifies the relationship between two nodes as an edge value, for example in the form of a correlation between the corresponding node sizes. Instead of the correlation, which can be ascertained, for example, by comparing the courses of the two node variables in question, other functions can also be used with which two of the node variables are related to each other. A mathematical sensor state graph formulated in this way then reflects the detected sensor state, which is then specified by the values of the detection variables as nodes and the edge values of the edges between two nodes.

Using a neural graph network, the data structure of the sensor state graph can be converted into an output vector. The output vector contains an output variable as a correction variable for correcting the detection variable or as a corrected sensor output variable. The output vector also includes other auxiliary variables that can be used for the recalibration process.

The output vector, which is obtained using the neural graph network, is designed to output an output variable on the one hand and to provide an output suitable for ascertaining a loss for training the neural graph model through the auxiliary variables on the other. The loss corresponds to an indication of the precision or predictive accuracy of the calibration model and is used for training the calibration model. The above method makes it possible to ascertain a loss that is suitable for unsupervised retraining of the neural graph network by representing a sensor state in the form of a sensor state graph and using a neural graph network by augmenting the sensor state graph.

Augmenting the sensor state graph can be performed by randomly removing one or more of the nodes, by randomly removing one or more of the edges, by randomly swapping node sizes and/or by randomly swapping edge sizes.

When augmenting the sensor state graph, one or more nodes and/or one or more edges can be removed or swapped in a known manner. The nodes and/or edges are omitted or swapped at random. The options can be restricted so that only certain augmentations are possible. For example, random, specific rotations of the graph can also be realized. Other augmentation options are also conceivable, such as the specific modification of numerical values, etc.

In this way, it is possible to calibrate the sensor system without ascertaining labels, for example by hiding and/or swapping individual influencing variables by augmenting the mathematical graph on the input side. By coupling the output of the correction variable and the auxiliary variables for the unsupervised learning of the calibration model during an initial training process, recalibration can be carried out efficiently.

As soon as the sensor state is available as a mathematical graph in the form of values of the one or more detection variables and the one or more state variables for a time of detection, this can be evaluated using the data-based calibration model in order to obtain the output variable. The data-based calibration model is designed and trained as a neural graph network to provide the output vector with the output variable and the auxiliary variables.

A recalibration can be carried out at the same time or at specified times, which may be regular. For this purpose, the calibration model is further trained using an unsupervised training method in order to compensate for the increasing deviations due to ageing and environmental influences. The unsupervised training method uses the advantage that missing input data is irrelevant for neural graph networks and an evaluation can still be carried out. The unsupervised training method uses an augmented sensor state graph to determine a loss required for training.

According to one embodiment, the loss can be determined by
the calibration model is used to provide an evaluation model that corresponds to the calibration model or that comprises one or more further downstream neuron layers or data-based models in addition to the calibration model,
a twin model is provided that is trained in the same way as the evaluation model and has a different configuration with regard to the evaluation model,
an augmented sensor state graph is evaluated by the evaluation model to obtain an evaluation vector;
another augmented sensor state graph is evaluated by the twin model to obtain another evaluation vector; and
the loss is ascertained as a measure of the difference between the valuation vectors.

Here, a first and a second augmented sensor state graph can be created for the unsupervised training method of the data-based calibration model.

The evaluation is now carried out using an evaluation model in order to obtain a first output vector with the auxiliary variables.

In addition to the evaluation model, a twin model is provided, which is designed and trained as a neural graph network in the same way as the calibration model, but has a different configuration and, in particular, is based on a different set of hyperparameters. For example, the evaluation model may use the calibration model unchanged or may be supplemented with a first number of downstream neuron layers (e.g. in the form of Fully Connected Layers) to the evaluation model while providing the twin model which has a completely different configuration from the evaluation model. The twin model can be formed, for example, by the calibration model with a second number of downstream neuron layers (e.g. in the form of fully connected layers) that differs from the first. The evaluation model and twin model are designed in such a way that the format of the respective output vector is the same, so that a difference between the output vectors can be evaluated in a simple manner.

In this way, the first augmented sensor state graph is evaluated by the evaluation model and the second augmented sensor state graph is evaluated by the twin model. The difference between the resulting output vectors can be evaluated by a loss.

For example, the loss L can be calculated based on a Euclidean distance of the two resulting output vectors y_{Kalmod}, y_{twin} of a cosine similarity,

$$L = 2 - 2 \frac{{y}_{Kalmod} {y}_{twin}}{{‖ {y}_{Kalmod} ‖}^{2} {‖ {y}_{twin} ‖}^{2}}$$

wherein y_{Kalmod} corresponds to the output vector of the evaluation model and y_{twin} corresponds to the output vector of the twin model.

The loss is used to retrain both the evaluation model and the twin model using known gradient-based methods such as backpropagation, so that this can be used to ascertain the output variable during conventional operation of the sensor system.

The evaluation model and the twin model are initially trained together in an initial calibration process using labeled data. For this purpose, the training of the calibration model together with a loss is performed in a conventional manner based on training data sets, which includes the sensor state graph representing a sensor state at a certain time of detection and associated labels as the output variable to adjust the model output of the output variable in the output vector by the calibration model, and on the other hand, by the unsupervised training by augmenting the mathematical sensor state graph to obtain the corresponding auxiliary variables of the output vector of the calibration model. In addition to traditional training using backpropagation, meta-learning or few-shot learning can also be used for this purpose. The twin model can be initially trained in a similar way. By alternately training the calibration model with the training data sets and modifying it to the evaluation model and the twin model using the unsupervised training method, a suitable coupling of the output variable and the auxiliary variables in the output vector can be achieved.

The joint loss can be used to train the valuation model (modified calibration model) and the twin model. Since the loss is calculated using both models, the gradients for both models can be calculated with one loss. The resulting loss is calculated backwards using backpropagation, for example, and the gradients are thus calculated. This means that the backpropagation is calculated backwards using both models. Usually the gradients are applied with different learning rates for both models, but it can also be an identical learning rate.

In a further embodiment of the unsupervised training method for the data-based calibration model, it may be provided that the calibration model is provided such that the auxiliary variables indicate an output graph of the calibration model, wherein the loss is determined by evaluating the calibration model using the augmented sensor state graph to obtain a reconstructed sensor state graph and ascertaining the loss as a measure of a difference between the original sensor state graph and the reconstructed sensor state graph.

Here, the auxiliary variables of the output vector are a representation of a sensor state graph that has the form (number of nodes and linkage through the edges) of the original non-augmented sensor state graph. The auxiliary variables can be used as parameters to describe the sensor state graph.

The auxiliary variables can be determined depending on an augmented sensor state graph by evaluating the calibration model, wherein the auxiliary variables should indicate a reconstruction of the original sensor state graph. Training can be performed with a loss resulting from the difference between the original sensor state graph (before augmentation) and the reconstructed sensor state graph. The difference can be expressed as the Euclidean distance between the original sensor state graphs and the vectors (or tensors) describing the reconstructed sensor state graphs.

According to one embodiment, the data-based calibration model can be initially trained before commissioning the sensor system by ascertaining the loss for a plurality of sensor states and determining a further loss from training data sets for supervised training, wherein a total loss is determined from the loss and the further loss, wherein the calibration model is initially trained based on the total loss.

Once the sensor system has been manufactured, the calibration model is initially trained using labeled training data that assigns a sensor state graph to an output variable of an output vector. The initial training is performed alternately or simultaneously (with a common loss) with a step of the unsupervised training method based on an augmented sensor state graph as described above, wherein the output vector of the calibration model specifies the output variable and the auxiliary variables for determining the unsupervised loss. The auxiliary variables can describe a graph in the format of a sensor state graph.

During operation, a loss based on augmented sensor state graphs is now ascertained by means of exclusively unsupervised training and the calibration model is thus retrained, e.g. based on gradient-based training methods. This results in a corresponding adjustment of the output variable(s) in the output vector when evaluating the calibration model, as this is directly connected to the auxiliary variables of the output vector via the calibration model. This makes it possible to carry out an improved recalibration during operation of the sensor system without labeled training data sets.

### BRIEF DESCRIPTION OF THE DRAWINGS

Preferred embodiments are described in more detail below with reference to the accompanying drawings. Shown are:

FIG. 1 an exemplary sensor system for providing a value of a sensor output variable with an implemented calibration model that can be retrained;

FIG. 2 is a schematic representation of a sensor state graph;

FIG. 3 is a schematic representation of a method for the unsupervised retraining of a calibration model according to a first embodiment;

FIG. 4 is a flowchart illustrating a method for unsupervised retraining of the calibration model as shown in FIG. 3;

FIG. 5 a schematic representation of a model for unsupervised retraining of a calibration model according to a further embodiment; and

FIG. 6 a flowchart illustrating a method for retraining the calibration model as shown in FIG. 5.

### DETAILED DESCRIPTION

FIG. 1 shows a schematic representation of a sensor system 1 with a sensor element 2 for detecting one or more physical variables, such as an acceleration, a radiation, a vibration, a filling level, etc., and for providing one or more detection variables E, in particular electrical detection variables, which depend on the one or more physical variables. The one or more detection variables E are pre-processed by a pre-processing unit 3, such as amplified and/or filtered. The detection variables E can also be used to represent several physical variables of the same type, such as accelerations in several spatial directions.

Furthermore, one or more state sensors 4 are provided to detect state variables Z. These state variables Z can, for example, represent ambient conditions and indicate, for example, a temperature, a humidity, an air pressure, a mechanical stress load, such as a bending load, a vibration load, a load due to electromagnetic radiation and the like. Furthermore, the state variables can also represent internal sensor signals that indicate the state of the sensor system. For example, the state variables can indicate the quadrature of an acceleration sensor or the operating voltage of a laser diode. The one or more state variables Z can also be pre-processed by the pre-processing unit 3, such as amplified and/or filtered.

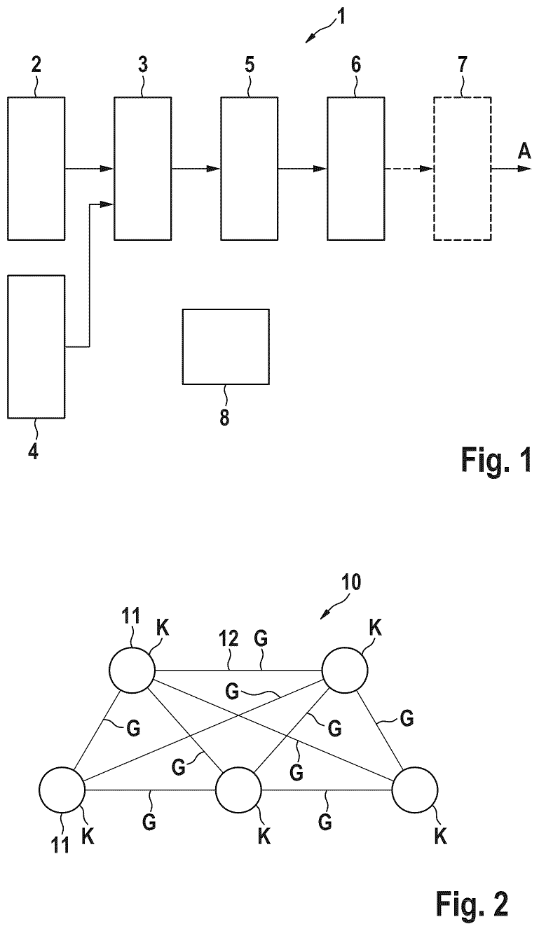

In a graph creation unit 5, the one or more detection variables E and the one or more state variables Z are processed to form a mathematical sensor state graph 10. Such a sensor state graph is shown as an example in FIG. 2. The one or more detection variables E and the one or more state variables Z are referred to as node variables K, which are assigned to the nodes 11 of the sensor state graph. The nodes 11 of the sensor state graph are connected or related to each other by edges 12, wherein the edges 12 are assigned a respective edge size G.

The edge sizes G can indicate the edge relationships between the node sizes, for example in the form of a correlation between the node sizes. The correlation can be ascertained by comparing the temporal progression of the respective node variables within a predetermined time window, which can end at a current point in time (the last samples ascertained). Furthermore, the edge sizes G can also indicate a relationship between two node sizes K represented by the nodes 11 in another form. The resulting mathematical sensor state graph 10 indicates the state of the sensor system 1 at a specific time step, i.e. at a time of detection.

The edge sizes can be ascertained once in specific measurement series. Time series can be recorded under different ambient conditions in order to record time series in time windows and determine the correlation values. Furthermore, the edge sizes can also be ascertained by the preceding supervised training by varying the edge sizes during the training in order to ascertain the optimum values in a kind of hierarchical training. The training can be repeated several times with different edge sizes, which can be varied in a Bayesian manner, for example.

The sensor state graph is now fed to a trained data-based calibration model 6, which is initially trained. On the output side of the calibration model, an output vector with an output variable for each of the one or more detection variables E and other auxiliary variables is output. The one or more output variables can correspond to a sensor output variable A, which in particular can be corrected according to the calibration model 6 and which can be clearly assigned to the measure of the physical variable represented by the respective detection variable E. Alternatively, the respective output variable can also be a correction variable that can be applied to the respective detection variable, e.g. in an optional application block 7, for example additively or multiplicatively, in order to calculate the sensor output variable A depending on the sensor state.

The calibration model 6 is initially trained based on training data sets in which a sensor state graph is assigned to one or more output variables that correspond to the measured physical variable or from which it can be ascertained. The initial training of the calibration model is described in more detail below.

During operation of the sensor system 1, deviations in the sensor behavior occur due to ageing effects and/or ambient influences, so that the calibration model 6 is increasingly less adapted to the real sensor system 1. The resulting sensor output variable can therefore represent the measured physical variable increasingly poorly, which falsifies the measurement result. A calibration control unit 8 is provided for this purpose, which performs a recalibration during operation of the sensor system 1 in an end application regularly or at predetermined times or triggered externally using an unsupervised training method.

Embodiments for performing a recalibration of the calibration model 6 are described in more detail below.

During recalibration, the data-based calibration model 6 or its model parameters are changed so that the one or more detection variables are corrected in a different way. The training of the data-based calibration model 6 aims to provide one or more output variables, each of which corresponds to the sensor output variable as a corrected detection variable or a correction variable for subsequently correcting the detection variable and is suitable for or contributes to providing a sensor output variable associated with the corresponding physical variable.

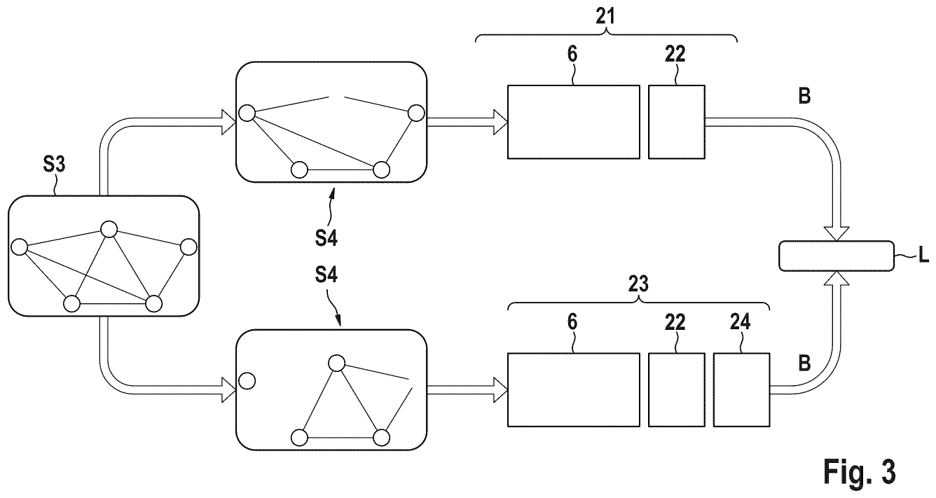

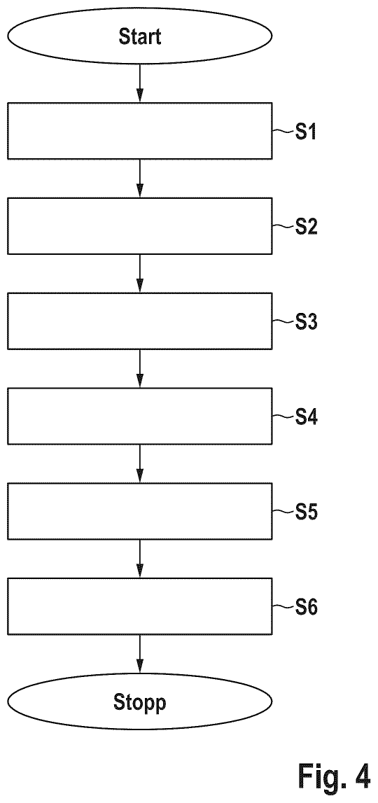

Using the schematic diagram in FIG. 3 and the flow chart in FIG. 4, a method for retraining the calibration model is now described in more detail. In step S1, the method is based on the provision of a calibration model 6 that has initially been trained based on training data sets.

In step S2, a sensor state is detected for a specific time step or time of detection and a sensor state graph is created in step S3 as described above. The sensor state is indicated by the one or more detection variables and the one or more state variables.

In a subsequent step S4, a first augmented sensor state graph and a second augmented sensor state graph are generated from the sensor state graph. The sensor state graph can be augmented by omitting nodes and/or edges or swapping nodes and edges, as shown schematically in FIG. 3. Augmentation takes place randomly and is carried out independently of the values of the detection variables and/or one or more state variables.

An evaluation model 21 is provided, which can correspond to the calibration model and provide the output vector as evaluation vector B. Alternatively, the evaluation model may comprise the calibration model 6 and one or more further downstream first neuron layers 22 in the form of fully-connected layers (MLP), which further process the output vector of the calibration model and provide an evaluation vector on the output side. Other extensions with one or more neuron layers or other data-based models are also conceivable.

Furthermore, a twin model 23 is provided, which is trained in a manner identical to the evaluation model 21, but has a different configuration 24. The twin model 23 may comprise the calibration model 6 and may be modified in a different manner than the evaluation model 21 to realize the difference in configuration 24.

During the initial training of the evaluation model 21, the twin model 23 is also trained with the aim of providing an evaluation vector B that is identical to the evaluation model 21. The evaluation model 21 and the twin model 23 are each suitable for processing a graph as an input variable and outputting the evaluation vectors B, which have similar formats.

Like the calibration model, the twin model 23 is also designed as a neural graph network, but can have a different structure based on a different selection of hyperparameters.

The evaluation model 21 and the twin model 23 can also be identical but extended by different numbers of subsequent fully connected layers, so that both data-based neural graph network models are not 1:1 copies of each other and have different configurations.

As part of an unsupervised training step for retraining the calibration model, the evaluation model 21 with the first augmented sensor state graph and the twin model 23 with the second augmented sensor state graph are evaluated in step S5 in order to obtain the evaluation vectors B.

In step S6, the evaluation model 21 and the twin model 23 are trained using a loss L. The loss is obtained by comparing the evaluation vectors B of the evaluation model 21 and the twin model 23 as a difference between the respective resulting evaluation vectors B. For this purpose, the evaluation vectors B can be checked with respect to a Euclidean distance or a cosine similarity in order to ascertain the loss L. The loss L essentially evaluates the distance between the valuation vectors B.

Post-training is carried out for both the evaluation model 21 and the twin model 23 based on gradient-based training methods. Since the calibration model 6 is included in the evaluation model 21, it is adapted to the sensor state during this process. The calibration model 6 is then used to correct the detection signal and improve the performance of the sensor system 1.

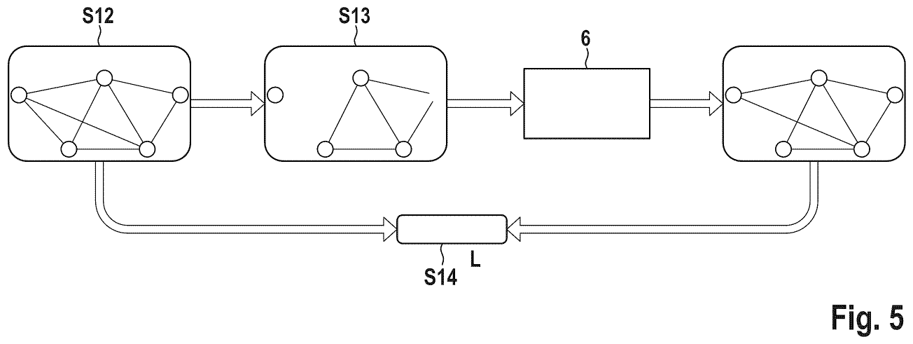

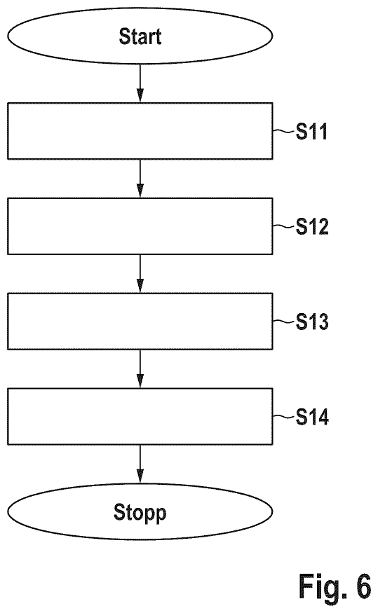

According to a further embodiment, retraining can be carried out without the use of a twin model 23. A method for retraining the calibration model 6 is now described in more detail using the schematic diagram in FIG. 5 and the flow diagram in FIG. 6. In step S11, the method is based on the provision of a calibration model 6 that has been initially trained based on training data sets.

In step S12, a sensor state is detected for a specific time step or time of detection and a sensor state graph 10 is created as described above. The sensor state is indicated by the one or more detection variables E and the one or more state variables Z.

For this purpose, in step S13, an augmented sensor state graph 10 is ascertained in the manner described above from the sensor state graph 10 of a current sensor state or of a sensor state at a specific point in time in the manner described above. This sensor state graph 10 is augmented and fed to the calibration model 6.

The calibration model 6 is designed to provide an output vector by evaluating the augmented sensor state graph, which on the one hand comprises the one or more output variables A and auxiliary variables representing a sensor state graph 10 whose format corresponds to an original sensor state graph.

Thus, the calibration model 6 can be designed to reconstruct a sensor state graph 10 from an augmented sensor state graph that corresponds to the original sensor state graph in addition to the output of the output variables—described by the auxiliary variables. By comparing the original sensor state graph with the reconstructed sensor state graph, a loss L can be ascertained as the weighted difference between the sensor state graphs 10. The difference can be determined based on parameters of the sensor state graphs, which can be described e.g. as graph vectors, in particular by ascertaining a Euclidean distance or a cosine similarity of the two graph vectors.

In step S14, the calibration model 6 is trained based on the loss L.

This embodiment has the advantage that only a single augmentation of the sensor state graph needs to be performed and only one data-based neural graph network model needs to be trained.

In this way, the model parameters of the data-based calibration model 6 can also be adjusted accordingly and applied online, i.e. while the sensor system 1 is in operation.

Before using the sensor system 1, it is necessary to initially train the calibration model 6. The elements of the output vector, namely the one or more output variables A and the auxiliary variables, are set in relation to each other in such a way that during the unsupervised training during operation of the sensor system 1—as described above—the model parameters of the calibration model 6 are changed in such a way that an optimum adaptation or correction of the detection variables can take place.

When initially training the calibration model, it is necessary to link the one or more output variables to be ascertained with the auxiliary variables that are also output in a suitable manner. Combined training is provided for this purpose, which alternately or in parallel performs monitored training based on training data sets and monitored training based on the loss, which is ascertained, for example, using one of the training methods described above. Training is preferably carried out under varying ambient conditions (i.e. varying state variables) for a large number of different values of physical variables in order to achieve the most space-filling representation of an input data space possible by the calibration model.

The training data sets for the monitored training result from measuring the sensor system on a test bench, in which one or more physical variables that are to be measured by the sensor system and the corresponding detection variables are specifically detected. The applied physical variables are assigned to a sensor output variable that the sensor system should output if the corresponding physical variables are available. Thus, the training data sets correspond to an input vector from the one or more detection variables and the one or more state variables (for a particular physical variable being applied), which are labeled with the corresponding sensor output variable associated with the respective physical variable.

While the Loss L_{unsupervised} for the unsupervised training is largely based on the evaluation of the auxiliary variables on the output side of the calibration model 6, the ascertaining of the supervised Loss L_{supervised} is based on the respective evaluation of the training data sets, in particular from the comparison of the label of the training data set with the output one or more output variables of the calibration model.

Both loss values L_{unsupervised}, L_{supervised} resulting from this can be offset to a total loss Lₜₒₜₐₗ as follows:

$${L}_{total} = {λ}_{1} \cdot {L}_{unsupervised} + {λ}_{2} \cdot {L}_{supervised} .$$

wherein λ₁ and λ₂ are weighting factors that can be defined in advance. In this way, the calibration model 6 can be initially trained to solve both tasks together, namely the output of the one or more correct output variables and the output of auxiliary variables that enable the unsupervised retraining of the calibration model.

The recalibration can be carried out during each time of detection step before the ascertaining of one or more output variables, so that the most current state of the sensor system can be taken into account when ascertaining the output variable(s).

Furthermore, it may be provided that, in addition to the step of retraining, the calibration model 6 is reset at each time of detection of the sensor system 1, i.e. the model parameters of the calibration model 6 are reset to the initial values obtained by the initial training. This has the advantage that the recalibration cannot lead to a deviation of the model parameters of the calibration model 6 that is too high and therefore the performance deteriorates again over time. Instead, only a foreseeable parameter space for the variation of the model parameters of the calibration model can be achieved, which can already be controlled and defined during the training phase for a safe application.

What is claimed is:

1. A computer-implemented method for recalibrating a trained data-based calibration model for the use in a sensor system for measuring one or more physical variables, wherein the data-based calibration model is formed as a neural graph network which is trained to output an output vector comprising one or more output variables and a plurality of auxiliary variables in dependence on a sensor state graph representing a sensor state, the method comprising:
detecting one or more detection variables relating to the one or more physical variables and one or more state variables which indicate one or more environmental influences on the sensor system at a time of detection;
ascertaining a sensor state graph depending on the one or more detection variables and the one or more state variables;
augmenting the sensor state graph;
evaluating the augmented sensor state graph with the data-based calibration model to obtain the output vector;
determining a loss depending on the output vector; and
training in an unsupervised manner the calibration model depending on the determined loss.

2. The method according to claim 1, wherein the sensor state graph is ascertained by assigning to nodes of the sensor state graph node variables which correspond to the one or more detection variables and the one or more state variables at the time of detection, and assigning to edges of the sensor state graph, which in each case connect two nodes of the sensor state graph to one another, in each case an edge variable which indicates a correlation between the detection variables or state variables within a predetermined time window, state variables represented by the respective edge, wherein the correlation is determined by evaluating time courses of the detection variables or state variables within a predetermined time window.

3. The method according to claim 2, wherein the augmenting of the sensor state graph is performed by randomly removing one or more of the nodes, by randomly removing one or more of the edges, by randomly swapping node sizes and/or by randomly swapping edge sizes.

4. The method according to claim 1, wherein the loss is determined by
the calibration model is used to provide an evaluation model which corresponds to the calibration model or which, in addition to the calibration model, comprises one or more further downstream neuron layers or data-based models,
a twin model is provided which is trained in the same way as the evaluation model and has a different configuration with respect to the evaluation model,
an augmented sensor state graph is evaluated by the evaluation model to obtain an evaluation vector,
a further augmented sensor state graph is evaluated by the twin model to obtain a further evaluation vector, and
the loss is ascertained as a measure of the difference between the valuation vectors.

5. The method according to claim 4, wherein both the evaluation model and the twin model are retrained depending on the loss.

6. The method according to claim 4, wherein the loss is ascertained as a cosine similarity or as a Euclidean distance.

7. The method according to claim 1, wherein the calibration model is provided such that the auxiliary variables indicate an output graph of the calibration model;
wherein the loss is determined by
the calibration model being evaluated using the augmented sensor state graph to obtain a reconstructed sensor state graph;
the loss is ascertained as a measure of a difference between the original sensor state graph and the reconstructed sensor state graph.

8. The method according to claim 1, wherein the data-based calibration model is initially trained before commissioning the sensor system by ascertaining the loss for a plurality of sensor states and a further loss is ascertained from training data sets for a supervised training, wherein a total loss is determined from the loss and the further loss, whereby the calibration model is initially trained.

9. The method according to claim 1, wherein the one or more output variables comprise one or more correction variables for applying to the one or more detection variables to obtain one or more sensor output variables depending on the one or more correction variables, or wherein the one or more output variables correspond to the one or more sensor output variables.

10. The method according to claim 1, wherein the calibration model is used by determining the sensor state graph depending on the one or more detection variables and the one or more state variables, wherein the one or more output variables are determined depending on the sensor state graph.

11. An apparatus comprising a data processing device adapted to carry out the method according to claim 1.

12. A computer program product comprising instructions which, when executed by at least one data processing device, cause the data processing device to perform the steps of the method according to claim 1.

13. A machine-readable storage medium comprising instructions which, when executed by at least one data processing device, cause the data processing device to perform the steps of the method according to claim 1.
